(19) United States
(12) Patent Application Publication
(10) Pub. No.: US 2026/0050769 A1
(43) Pub. Date: Feb. 19, 2026

(54) COMMENT SUMMARIZATION USING DIFFERENTIAL PROMPT ENGINEERING ON A LANGUAGE MODEL

(71) Applicant: Google LLC, Mountain View, CA (US)

(72) Inventor: Dongeek Shin, San Jose, CA (US)

(21) Appl. No.: 18/808,957

(22) Filed: Aug. 19, 2024

(51) Int. Cl. G06N 3/0455; G06F 16/34

(52) U.S. Cl. CPC G06N 3/0455; G06F 16/345

(57) ABSTRACT

An example computing system includes one or more processors; and one or more storage devices that store instructions. The instructions, when executed by the one or more processors, may cause the one or more processors to: obtain a comment from a comment datastore; determine a respective semantic distance between the comment and each semantic cluster from a set of semantic clusters; determine whether the respective semantic distance indicating a greatest semantic similarity between the comment and a semantic cluster from the set of semantic clusters satisfies a threshold; responsive to a determination that the respective semantic distance satisfies the threshold, update a summary by at least applying a machine learning model to the comment, wherein the machine learning model is a language model; and store the summary to a datastore.

### BACKGROUND

A comment section of a user application offers users a chance to share their thoughts and opinions while also allowing them to view the thoughts and opinions shared by other users. However, typically a user must manually scroll through all the comments in the comment section if they want to gain a globally relevant understanding of the comments shared by the other users. Users may find it challenging and/or time-consuming to navigate through an entire comment section, especially when the comment section contains thousands of comments.

### SUMMARY

In general, techniques of this disclosure are directed to techniques for providing one or more summaries each summarizing at least a portion of a comment section by applying a framework which surrounds a language model (LM) to update one of the summaries if a new or edited comment causes a meaningful change in the comment section. A user application (e.g., a video sharing forum) may include a continuously changing comment section with comments relating to different topics and organized in a serial list format. As various users add new comments, reply to existing comments, or edit existing comments, the comment section may expand and be difficult to read or otherwise follow. While modern summarization engines, such as an LM, have been used in various applications to generate summaries of text, due to their high computational resource usages, LMs alone may not be able provide summaries that represent all the comments in the comment section much less in real or near real time as users continue to add new comments. As a result, the summaries generated by the LM may not be globally relevant (i.e., may not consider all the relevant comments) and may be outdated by the time the summaries are generated.

In accordance with one or more aspects of this disclosure, a computing system may analyze any new or edited comments to assign them to a cluster that represents at least a portion of the comments within the comment section. The computing system may determine if the new or edited comments are sufficiently different from the other comments assigned to the cluster so as to cause the current summary associated with that cluster to be inaccurate, insufficient, or otherwise incomplete. If the computing system determines that the summary for a portion of the comment section needs to be updated, rather than processing all of the comments of the comment section, the computing system may use select past summaries, select representative comments, or other limited representations of the comments of the comment section to generate an updated summary for the comment section.

For instance, a user application may display a video about a dog chasing a seagull on a beach and may have a comment section with thousands of comments. The comments may be displayed in a serial list and the computing system may have assigned each comment in the comment section into one of three clusters. The first cluster may include comments related to the dog, the second cluster may include comments related to the seagull, and the third cluster may include comments related to the beach. In one example of the thousands of comments, 30 are new or edited comments. The computing system may analyze each of the new or edited comments to assign them to a cluster and determine if the new or edited comments are sufficiently different from the comments of their respective clusters to trigger a summary update for that cluster. If the computing system determines that one of the new or edited comments triggers a summary update for the comment's respective cluster, the computing system inputs, into the LM, a representation of the new or edited comment and at least some type of limited representation of the comment section (if available) to generate an updated summary. In one example, a summary may be generated for each cluster or for a plurality of clusters. In this way, aspects of the disclosure may improve comment summarization using an LM while incurring fewer computational expenses than traditional LM summarization techniques.

In one example, a method includes obtaining, by a computing system, a comment from a comment datastore; determining, by the computing system, a respective semantic distance between the comment and each semantic cluster from a set of semantic clusters; determining, by the computing system, whether the respective semantic distance indicating a greatest semantic similarity between the comment and a semantic cluster from the set of semantic clusters satisfies a threshold; responsive to determining that the respective semantic distance satisfies the threshold, updating, by the computing system, a summary by at least applying a machine learning model to the comment, wherein the machine learning model is a language model; and storing, by the computing system and to a datastore, the summary.

In another example, a computing system includes one or more processors; and one or more storage devices that store instructions, wherein the instructions, when executed by the one or more processors, configure the one or more processors to: obtain a comment from a comment datastore; determine a respective semantic distance between the comment and each semantic cluster from a set of semantic clusters; determine whether the respective semantic distance indicating a greatest semantic similarity between the comment and a semantic cluster from the set of semantic clusters satisfies a threshold; responsive to a determination that the respective semantic distance satisfies the threshold, update a summary by at least applying a machine learning model to the comment, wherein the machine learning model is a language model; and store the summary to a datastore.

In another example, various aspects of the techniques are directed towards a non-transitory computer-readable storage media encoded with instructions that, when executed by one or more processors of a computing system, cause the one or more processors to: obtain a comment from a comment datastore; determine a respective semantic distance between the comment and each semantic cluster from a set of semantic clusters; determine whether the respective semantic distance indicating a greatest semantic similarity between the comment and a semantic cluster from the set of semantic clusters satisfies a threshold; responsive to a determination that the respective semantic distance satisfies the threshold, update a summary by at least applying a machine learning model to the comment, wherein the machine learning model is a language model; and store the summary to a datastore.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating an example system for providing one or more summaries that each summarize at least a portion of a comment section of a user application, in accordance with one or more techniques of this disclosure.

FIG. 2 is a block diagram illustrating an example computing system configured to provide an updated summary, in accordance with one or more techniques of this disclosure.

FIG. 3 is a block diagram illustrating in further detail a machine learning module configured to provide an updated summary, in accordance with one or more techniques of this disclosure.

FIG. 4 is a flowchart illustrating an example mode of operation of an example system that provides one or more summaries, in accordance with one or more techniques of this disclosure.

### DETAILED DESCRIPTION

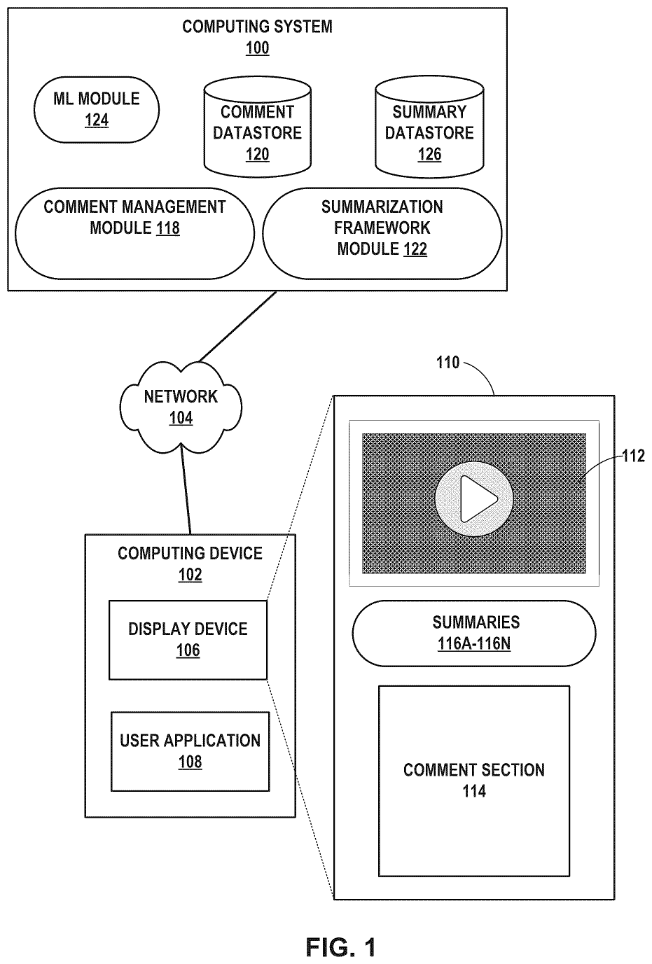

FIG. 1 is a conceptual diagram illustrating an example system for providing one or more summaries that each summarize at least a portion of a comment section of a user application, in accordance with one or more techniques of this disclosure. As shown in the example of FIG. 1, computing system 100 and computing device 102 may facilitate comment submission and generation of summaries of the submitted comments for inclusion within GUI 110.

Computing system 100 may be any suitable remote computing system, such as one or more desktop computers, laptop computers, mainframes, servers, cloud computing systems, virtual machines, etc. that may send and receive information via network 104. In some examples, computing system 100 may represent a cloud computing system that provides one or more services via network 104. That is, in some examples, computing system 100 may be a distributed computing system. One or more computing devices, such as computing device 102, may access the services provided by the cloud by communicating with computing system 100.

Computing device 102 may be any mobile or non-mobile computing device, such as a cellular phone, a smartphone, a desktop computer, a laptop computer, a tablet computer, a portable gaming device, a portable media player, an e-book reader, a watch (including a so-called smartwatch), computing headsets, an add-on device (such as a casting device), smart glasses, a gaming controller, or another type of computing device.

Computing device 102 and computing system 100 may receive and transmit information via network 104. Network 104 may include a wide-area network such as the Internet, a local-area network (LAN), a personal area network (PAN) (e.g., Bluetooth®), an enterprise network, a wireless network, a cellular network, a telephony network, a Metropolitan area network (e.g., WIFI, WAN, WiMAX, etc.), one or more other types of networks, or a combination of two or more different types of networks (e.g., a combination of a cellular network and the Internet).

Computing device 102 may include display device 106 and user application 108. Display device 106 may be a foldable or rollable display. Display device 106 may be a presence-sensitive display that functions as an input device and as an output device. For example, display device 106 may function as an input device using a presence-sensitive input component, such as a resistive touchscreen, a surface acoustic wave touchscreen, a capacitive touchscreen, a projective capacitance touchscreen, a pressure sensitive screen, an acoustic pulse recognition touchscreen, or another presence-sensitive display technology. Display device 106 may function as an output (e.g., display) device using any of one or more display components, such as a liquid crystal display (LCD), dot matrix display, light emitting diode (LED) display, microLED display, miniLED display, organic light-emitting diode (OLED) display, e-ink, active matrix organic light-emitting diode (AMOLED) display, or similar monochrome or color display capable of outputting visible information to a user of computing device 102.

A user of computing device 102 may download, install, and execute user application 108. User application 108 may include a plurality of user applications and may represent a first party application developed and provided as an application integrated into an operating system or a third-party application that a user of computing device 102 obtains via application store services provided by way of the operating system. User application 108 may extend software functionality of computing device 102, where user application 108 may execute within an execution environment presented by the operating system. User application 108 may, as a few examples, provide user access to platforms, hubs, channels, and/or networks that include the posting, outputting, and/or viewing of user written text (i.e., comments). In other examples, user application 108 may provide user access to gaming services (e.g., video games), email services, web browsing services, texting and/or chat services, web conferencing services, video conferencing services, music services (including streaming music services), video services (including video streaming services), navigation services, word processing services, spreadsheet services, slide and/or presentation services, assistant services, text entry services, or any other service commonly provided by applications. In some examples, user application 108 may represent web applications and web-based services and enable user access and interaction with the content and functionality provided by websites.

In one example, user application 108 may be a video viewing and sharing application. In such an example, user application 108 may generate GUI 110 such that GUI 110 includes a video (e.g., video 112), a comment section that includes user-provided comments (e.g., comment section 114), and one or more summaries each summarizing one or more of the user-provided comments (e.g., summaries 116A-116N). Video 112 may be a recording of moving visual images which may be accompanied by audio and viewed by the user repeatedly. In some examples, video 112 may relate to topics such as entertainment, education, news, tutorials, and personal experiences. Comment section 114 may include comments previously submitted by the user or other users. Comment section 114 may enable a user to view some or all of the comments submitted by the user or other users. Summaries 116A-N(collectively referred to as, “summaries 116”) may each include a summary of at least a portion (i.e., one or more comments) of the submitted comments within comment section 114.

A user of computing device 102 may submit a new comment into comment section 114 or edit a previously submitted comment already within comment section 114. In one example, in response to a user input, computing device 102 may send a representation of the user submitted new or edited comment to computing system 100. In various instances, a user input may be a user inputting a new comment, editing an already existing comment, or inputting a command (e.g., pushing a button).

Computing system 100 may send a request to computing device 102 requesting any new or edited comments. In response to the request, computing system 100 may receive a representation of the new or edited comments. In some examples, any information associated with each of the new or edited comments, such as a name or other identifier, time stamps (i.e., when the comment was created or edited), metadata (e.g., likes, dislikes, upvotes, downvotes, and replies), and multimedia data, such as images or videos may also be received by computing system 100.

Further, a user may be provided with controls allowing the user to make an election as to both if and when computing system 100 may enable collection of user information (e.g., a user's comment and information associated with the user's comment). In addition, certain comment data may be treated in one or more ways before the comment data is stored and/or used to generate a summary, so that personally identifiable or relevant information is not included in the summary. For example, a username associated with a comment and/or the comment itself may be treated so that no personally identifiable information can be determined for the user.

As shown in FIG. 1, computing system 100 includes comment management module 118, comment datastore 120, summarization framework module 122, machine learning (ML) module 124, and summary datastore 126. While described as being stored at and/or executed by computing system 100, in some examples, some or all of comment management module 118, comment datastore 120, summarization framework module 122, ML module 124, and summary datastore 126, may be stored at and/or executed at computing device 102 such that the functionality provided by one or more of comment management module 118, comment datastore 120, summarization framework module 122, ML module 124, and summary datastore 126 may be provided by computing device 102 without requiring computing device 102 to send and receive information with computing system 100. In other words, some or all of the techniques described in this disclosure may be performed locally at computing device 102.

Computing system 100 may execute modules 118, 122, and/or 124 with one processor or with multiple processors. In some examples, computing system 100 may execute modules 118, 122, and/or 124 as virtual machines executing on underlying hardware. Modules 118, 122, and/or 124 may execute as one or more services of an operating system or computing platform or may execute as one or more executable programs at an application layer of a computing platform.

Comment management module 118 may manage information transmission between computing system 100 and computing device 102. Comment management module 118 may be operable by computing system 100 to perform one or more functions, such as receive input, retrieve input, store input, send input, and send indications of such input to other components associated with computing system 100. Specifically, comment management module 118 may receive, in some examples via an API, the user submitted new or edited comment from user application 108 of computing device 102. Comment management module 118 may store the received comment in comment datastore 120.

Comment datastore 120 may include data storage for the user submitted comments received by computing system 100 from computing device 102. In some examples, the comments may be stored in comment datastore 120 for use by modules of computing system 100, such as the summarization framework module 122 and/or the comment management module 118. In general, comment datastore 120 may be considered as a storage repository, and may be configured as a database, flat file, table, or other data structure.

According to the techniques of this disclosure, computing system 100 may execute summarization framework module 122 to facilitate the generation of one or more summaries that each summarize at least a portion of the comments within comment section 114. Summarization framework module 122 may receive the new or edited comment via comment management module 118. Summarization framework module 122 may analyze the new or edited comment to determine if the comment includes content that is unique relative to a portion of the existing comments within comment section 114.

In one example, the comments within comment section 114 may relate to different topics. For instance, a video of a dog chasing a seagull on the beach may have a comment section 114 of twenty-five comments, five comments may be about the dog, five comments may be about the seagull, and five comments may be about the beach. Summarization framework module 122 may generate clusters from the comments in comment section 114 based on their semantic relationship (i.e., summarization framework module 122 may generate semantic clusters). In one example, summarization framework module 122 may generate three clusters, one for comments about the dog, one for comments about the beach, and one for comments about the seagull. Further, summarization framework module 122 may modify and store the semantic clusters as a set of semantic clusters. Summarization framework module 122 may assign the new or edited comment to a cluster of the set of semantic clusters that the comment is most similar to. Summarization framework module 122 may determine if the content of the comment is sufficiently different from the content of the cluster that the comment is most similar to. If the content of the comment is sufficiently different from the content of the cluster, then summarization framework module 122 may trigger a summary update for the cluster that the comment is assigned to.

Summarization framework module 122 may trigger one or more summary updates of comment section 114 that generate one or more summaries 116. Summarization framework module 122 may store summaries in summary datastore 126. In some examples, the summaries may be stored in summary datastore 126 for use by other modules of computing system 100, such as comment management module 118, and ML module 124. Comment management module 118 may send the data in datastores 120 and 126 to other modules within computing system 100. The summaries stored in summary datastore 126 may indicate an associated cluster. In general, summary datastore 126 may be considered as a storage repository, and may be configured as a database, flat file, table, or other data structure.

In one example, summarization framework module 122, based on determining that the comment includes content that is unique relative to the existing comments assigned to the clusters, may trigger ML module 124 to generate an updated summary for a cluster. The updated summary may incorporate the content of the previous summary for that cluster, as well as the content of the new or edited comment.

In other examples, summarization framework module 122 may determine that the comment does not include unique content relative to the existing comments assigned to the clusters. As such, summarization framework module 122 may not generate an updated summary for a cluster but may instead receive a different comment to analyze.

If summarization framework module 122 determines that an updated summary should be generated, summarization framework module 122 may cause ML module 124 to generate the updated summary. ML module 124 may be a language model (LM) that, with input from summarization framework module 122, generates an updated summary for a respective cluster. In one example, ML module 124 may summarize summaries 116 that each correspond to a respective cluster to provide a summary of a plurality of clusters (i.e., a summary of a plurality of portions of comment section 114).

Comment management module 118 may send a copy of the updated summary from summary datastore 126 to user application 108 of computing device 102, via network 104. User application 108 may replace one of the previous summaries 116 with the updated summary for display to the user via GUI 110 displayed by display device 106.

In this way, aspects of this disclosure may improve comment summarization using a LM while incurring fewer computational expenses than traditional LM summarization techniques. By generating an updated summary when a user inputs a comment containing unique content, users may be provided with an easy and efficient way to gain a globally relevant understanding of the comment section, and thus an accurate understanding of the thoughts and opinions of the other users. Further, using a limited representation of the comment section to generate an updated summary, as opposed to using every comment within the comment section, reduces computational expenses and allows summary updates in real or near real time as users continue to add new comments.

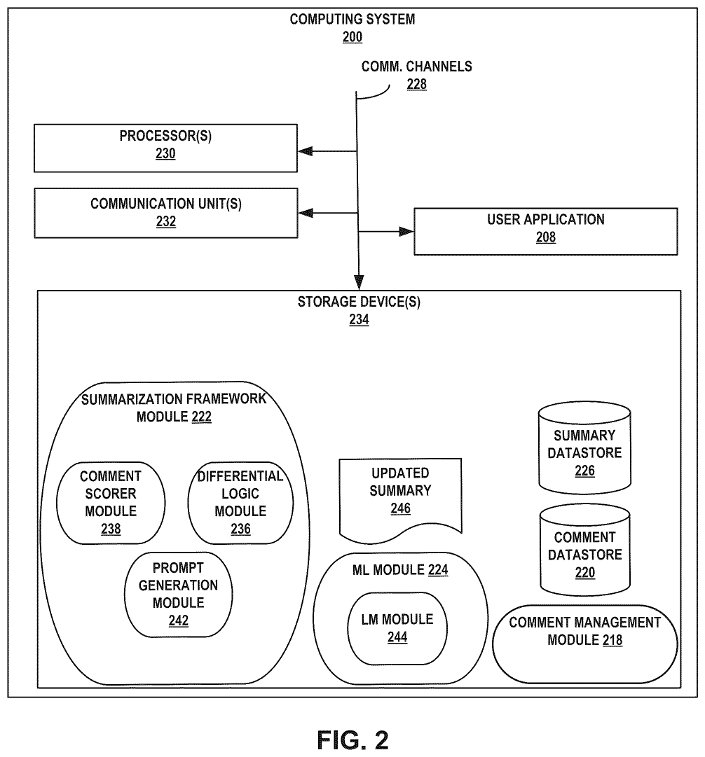

FIG. 2 is a block diagram illustrating an example computing system configured to provide an updated summary, in accordance with one or more techniques of this disclosure. Computing system 200 is one example of computing system 100 shown in FIG. 1. Computing system 200 includes user application 208, which may be similar if not substantially similar to user application 108 of FIG. 1, one or more communication channels 228, processors 230, one or more communication units 232, and one or more storage devices 234. Storage devices 234 of computing system 200 may include comment management module 218, comment datastore 220, summarization framework module 222, ML module 224, and summary datastore 226. Modules 218-226 may be similar if not substantially similar to modules 118-126 of FIG. 1. Some or all the components and/or functionality attributed to computing system 200 may be implemented or performed by a computing device in communication with computing system 200.

One or more communication units 232 of computing system 200 may communicate with external devices by transmitting and/or receiving data at computing system 200. For example, computing system 200 may use communication units 232 to transmit and/or receive radio signals and radio networks such as a cellular radio network. In some examples, communication units 232 may transmit and/or receive satellite signals on a satellite network such as a Global Positioning System (GPS) network. Example communication units 232 may include a network interface card (e.g., such as an Ethernet card), an optical transceiver, a radio frequency transceiver, or any other type of device that can send and/or receive information. Other examples of communication units 232 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 228 may interconnect processors 230, communication units 232, user application 208, and storage devices 234 for inter-component communications (physically, communicatively, and/or operatively). In some examples, communication channels 228 may include a system bus, a network connection, one or more communication data structures, or any other components for communicating data between hardware and/or software locally or remotely.

One or more processors 230 may implement functionality and/or execute instructions associated with computing system 200. Examples of processors 230 include application processors, display controllers, neural processors (i.e., neural processing units), graphics processors, auxiliary processors, one or more sensor hubs, and any other hardware configured to function as a processor, a processing unit, or a processing device. User application 208, comment management module 218, summarization framework module 222, ML module 224, and the like may be operable (or, in other words, executed) by processors 230 to perform various actions, operations, or functions of computing system 200. In one example, user application 208 may be a video viewing and sharing application that contains a comment section (e.g., user application 108 of FIG. 1) and is executed by processors 230. Some of modules 208 and 218-224 may form executable bytecode that, when executed, cause processors 230 to perform specific operations in accordance with (e.g., causing computing system 200 to become a specific-purpose computing system by which to perform) various aspects of the techniques described herein. For example, processors 230 of computing system 200 may retrieve and execute instructions stored by storage devices 234 that cause processors 230 to perform the operations described herein that are attributed to comment management module 218, summarization framework module 222, and ML module 224. The instructions, when executed by processors 230, may cause computing system 200 to store information within storage devices 234, such as comment datastore 220 and summary datastore 226.

In some examples, storage devices 234 may include one or more computer readable storage media. Storage devices 234 in some examples include one or more non-transitory computer-readable storage mediums. Storage devices 234 may be configured to store larger amounts of information than typically stored by volatile memory. Storage devices 234 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories.

Storage devices 234 may include comment datastore 220 and/or summary datastore 226 for storing select user submitted comments and generated summaries respectively. Comment datastore 220 may store user submitted comments with an indication of which cluster the user submitted comments are each assigned to and if the user submitted comments triggered a summary update. Summary datastore 226 may store previously generated summaries with an indication of which cluster the summaries are each associated with. Each datastore may be accessed by one or more of user application 208, comment management module 218, summarization framework module 222, and ML module 224.

In some examples, computing system 200 may include comment management module 218. Computing system 200 may use comment management module 218 to receive input, retrieve input, store input, and/or send input to other components associated with computing system 200. Specifically, a user may submit a new or edited comment within the comment section of video viewing and sharing user application 208. Comment management module 218 may obtain the user submitted new or edited comment from user application 208, via communication channels 228. Comment management module 218 may store the user submitted new or edited comment in comment datastore 220. Comment management module 218 may retrieve one or more comments from comment datastore 220. Comment management module 218 may send one or more comments to summarization framework module 222.

Summarization framework module 222 may analyze a new or edited user submitted comment from the comment section of user application 208 to generate one or more updated summaries 246 via ML module 224, in accordance with techniques of this disclosure. Summarization framework module 222 may include differential logic module 236, comment scorer module 238, and prompt generation module 242.

Summarization framework module 222 may obtain a comment, in some examples via comment management module 218. Summarization framework module 222 may perform preprocessing on the comment before analyzing the comment. Preprocessing of the comment may include, converting text to lowercase, removing punctuation, handling special characters, splitting text into individual words or tokens, removing common words, and/or reducing words to their root form. In some examples, summarization framework module 222 may then convert the comment text into a numerical representation that captures the semantic meaning of the comment (e.g., a vector).

Differential logic module 236 may determine the semantic distance between the comment (or a representation of the comment) and each cluster of a set of clusters for a comment section of user application 208. The semantic distance between the comment and each cluster may quantify how similar or dissimilar the content of the comment is to the content of each cluster. By determining the semantic distance between the comment and each cluster, differential logic module 236 may determine how similar or dissimilar the content of the comment is to the content of the entire comment section of user application 208. Of the one or more semantic distance values between the comment and each cluster of the set of clusters, one semantic distance value may indicate the greatest semantic similarity between the comment and a cluster of the set of clusters.

Comment scorer module 238 may receive from differential logic module 236, the semantic distance indicating the greatest semantic similarity between the comment and a cluster of the set of clusters. Comment scorer module 238 may also receive the comment and the cluster associated with the semantic distance indicating the greatest semantic similarity. Comment scorer module 238 may compare the semantic distance indicating the greatest semantic similarity to one or more thresholds to determine if an updated summary 246 should be generated for a cluster. The one or more thresholds may be a value that indicates a corresponding level of similarity or dissimilarity between the content of a comment and the content of a cluster. For example, a semantic distance indicating the greatest semantic similarity between a comment and a cluster of a set of clusters may be compared to a threshold to determine if the content of the comment is dissimilar enough to the content of the cluster for comment scorer module 238 to trigger an summary update for the cluster. The value of the thresholds may be modified. For example, by adjusting the value of the thresholds comment scorer module 238 may trigger summary updates more frequently.

Further, comment scorer module 238 may generate a set of clusters for a comment section. Comment scorer module 238, may assign each comment or a representation of each comment input into summarization framework module 222 to a cluster of a set of clusters for a comment section. Comment scorer module 238, may generate a new cluster of a set of clusters and assign a comment to the new cluster. In one example, a cluster may be a collection of comments (or other items/objects) that are grouped together based on certain similarities or characteristics. The comments within a cluster may be more similar to each other than to the comments within the other clusters.

Comment scorer module 238 may compare the semantic distance that indicates the greatest semantic similarity between the comment and a cluster of the set of clusters to a first threshold. If the semantic distance does not satisfy the first threshold, the content of the comment may be similar to the content of the cluster (i.e., the content within the comment section) such that comment scorer module 238 may refrain from triggering a summary update. However, comment scorer module 238 may assign the comment to the cluster associated with the semantic distance indicating the greatest semantic similarity. Summarization framework module 222 may then cease operation (i.e., refraining from updating the summary) until receiving a different comment to analyze.

If the semantic distance satisfies the first threshold the content of the comment may be dissimilar to the content within each of the clusters (i.e., the content within the comment section). Comment scorer module 238, may compare the same semantic distance that was compared against the first threshold (e.g., the semantic distance indicating the greatest semantic similarity) to a second threshold.

If the semantic distance satisfies the second threshold, the content of the comment may be so dissimilar to the content within each of the clusters (i.e., the content within the comment section) that comment scorer module 238 may generate a new cluster and assign the comment to the new cluster. Further, comment scorer module 238 may trigger a summary update for the new cluster.

If the semantic distance does not satisfy the second threshold, the content of the comment may be dissimilar to the content within each of the clusters (i.e., the content within the comment section), but not so dissimilar that comment scorer module 238 generates a new cluster. Instead, comment scorer module 238 may assign the comment to the previously generated cluster of the set of clusters that is most semantically similar to the comment. Comment scorer module 238 may trigger a summary update for the previously generated cluster that the comment is assigned to.

In one example, summarization framework module 222 may obtain a first comment from a comment section of user application 208. Differential logic module 236 may determine the semantic distance between the first comment (or a representation of the first comment) and each cluster of the set of clusters for the comment section. However, the set of clusters for the comment section may be an empty set due to summarization framework module 222 not receiving any comments prior to the first comment. Comment scorer module 238 may receive from differential logic module 236, the semantic distance between the first comment and the empty set of clusters. Comment scorer module 238 may compare the semantic distance value to the first threshold. Upon satisfying the first threshold, comment scorer module 238 may compare the semantic distance value to the second threshold. Upon satisfying the first and second thresholds comment scorer module 238 may generate a new cluster (i.e., the first cluster of the set of clusters for the comment section) for the first comment. Comment scorer module 238 may also trigger a summary update (i.e., trigger a summary generation) for the new cluster.

In one example, summarization framework module 222 may receive a new comment from a comment section of user application 208 via comment management module 218. Summarization framework module 222 may have previously received twenty comments from the comment section. Comment scorer module 238 may have previously generated a set of clusters that includes two clusters. Further, comment scorer module 238 may have assigned each of the twenty comments to one of the two clusters. Differential logic module 236 may determine the semantic distance between the new comment and each of the clusters of the set of clusters, resulting in two semantic distance values. Of the two semantic distance values, the one that indicates the greatest semantic similarity, along with the comment and cluster associated with the semantic distance value that indicates the greatest semantic similarity, are input into comment scorer module 238. Comment scorer module 238 may compare the semantic distance to a first threshold and, if the first threshold is satisfied, a second threshold. Based on the result of comparing the semantic distance to the thresholds, comment scorer module 238 may generate and/or assign the new comment to a cluster. Further, comment scorer module 238 may trigger a summary update for the cluster that the new comment is assigned to.

Comment scorer module 238 may trigger a summary update by sending the relevant comment and the cluster that the relevant comment is assigned to, to prompt generation module 242. In one example, comment scorer module 238 may send the relevant comment and a plurality of clusters of the set of clusters to prompt generation module 242. Prompt generation module 242 may apply one or more techniques (e.g., one or more templates, or algorithms) to the comment and the one or more clusters to generate a prompt (i.e., a prompt generated based on the comment and one or more clusters). As described herein, the prompt may be a natural language prompt that indicates instructions for ML module 224 (e.g., language model module 244, referred to herein as “LM module 244”) to generate an updated summary 246 for the cluster.

The prompt generated by prompt generation module 242 may be provided to ML module 224. ML module 224 may also receive as input one or more limited representations of the comment section, such as, one or more comments that have previously satisfied at least the first threshold, and/or one or more previously generated updated summaries 246. The limited representations input into ML module 224 may be associated with a plurality of clusters (i.e., comments and summaries from more than one cluster).

Comment management module 218 may retrieve an updated summary 246 and store updated summary 246 in summary datastore 226. In some examples, comment management module 218 may select one or more previously generated updated summaries from summary datastore 226 to send to ML module 224 as input.

While described herein as summarization framework module 222 generating an updated summary for a portion of the comment section (i.e., an updated summary for a cluster), aspects of this disclosure may be applicable to summarization framework module 222 generating an updated summary 246 for a plurality of portions of the comment section (i.e., an updated summary for a plurality of clusters of the set of clusters). For example, as a result of a semantic distance indicating the greatest semantic similarity between a comment and a cluster of a set of clusters for a comment section satisfying the first and/or second threshold, comment scorer module 238 may send the relevant comment and a plurality of clusters to prompt generation module 242. Prompt generation module 242 may send a prompt to ML module 224 indicating that ML module 224 should generate an updated summary 246 for the plurality of clusters (i.e., one summary for a plurality of portions of the comment section). ML module 224 may receive, in addition to the prompt, one or more limited representations of the comment section, such as previously generated summaries associated with the plurality of clusters and/or comments that previously passed the first threshold and were assigned to a cluster from the plurality of clusters.

By using a prompt and one or more limited representations of the comment section, ML module 224 may generate an updated summary 246 of a portion of a comment section. Thus, in this respect, ML module 224 may provide users with an easy and efficient way to gain a globally relevant understanding of the comment section in real or near real time while reducing computational expenses.

ML module 224 may employ a LM, such as LM module 244, that may generate updated summary 246. In one example, LM module 244 may be a large language model (LLM). LM module 244 may be a type of transformer-based neural network. A transformer-based neural network may refer to a type of deep learning architecture specifically designed for handling sequential data, such as text or time series. In other words, transformer-based neural networks like LMs may be configured to perform natural language processing (NLP) tasks, such as question-answering, machine translation, text summarization, and sentiment analysis. LM module 244 may be configured to perform tasks such as classification, sentiment analysis, entity extraction, extractive question answering, summarization, re-writing text in a different style, ad copy generation, and concept ideation.

Transformer-based neural networks may utilize a self-attention mechanism, which allows the model to weigh the importance of different elements in a given input sequence relative to each other. The self-attention mechanism may help LM module 244 effectively capture long-range dependencies and complex relationships between elements, such as words in a sentence.

LM module 244 may include an encoder and a decoder that operate to process and generate sequential data, such as structured text. Both the encoder and decoder may include one or more of self-attention mechanisms, position-wise feedforward networks, layer normalization, or residual connections. In some examples, the encoder may process an input sequence and create a representation that captures the relationships and context among the elements in the sequence. The decoder may then obtain the representation generated by the encoder and produce an output sequence. In some examples, the decoder may generate the output one element at a time (e.g., one word at a time), using a process called autoregressive decoding, where the previously generated elements are used as input to predict the next element in the sequence.

In some examples, LM module 244 may generate updated summary 246. Updated summary 246 may be a summary of the content included in one or more clusters. LM module 244 may generate updated summary 246 by determining a set of information types included in the structured text of one or more limited representations of the comment section. An information type may be or otherwise include a topic, theme, point, subject, purpose, intent, keyword, etc. In some examples, LM module 244 may determine the information type by leveraging a self-attention mechanism to capture the relationships and dependencies between words in the input sequence. For example, LM module 244 may tokenize (e.g., split) a sequence of words or subwords, which LM module 244 may convert into vectors (e.g., numerical representations) that LM module 244 can process. LM module 244 may use the self-attention mechanism to weigh the importance of each token in relation to the others. In this way, LM module 244 may identify patterns and relationships between the tokens, and in turn the words corresponding to the tokens, that indicate one or more information types of the one or more limited representations of the comment section.

Although primarily described herein as being a transformer-based neural network, LM module 244 may be or otherwise include one or more other types of neural networks. For example, LM module 244 may be or include an autoencoder. In some examples, the aim of an autoencoder is to learn a representation (e.g., a lower-dimensional encoding) for a set of data, typically for the purpose of dimensionality reduction. For example, in some examples, an autoencoder can seek to encode the input data and the provide output data that reconstructs the input data from the encoding. The autoencoder concept may be used for learning generative models of data. In some examples, the autoencoder can include additional losses beyond reconstructing the input data. LM module 244 may be or include one or more other forms of artificial neural networks such as, for example, deep Boltzmann machines, deep belief networks, stacked autoencoders, etc. Any of the neural networks described herein can be combined (e.g., stacked) to form more complex networks.

In some examples, LM module 244 may be or include one or more feed forward neural networks. In feed forward networks, the connections between nodes do not form a cycle. For example, each connection can connect a node from an earlier layer to a node from a later layer. In some examples, LM module 244 may be or include one or more recurrent neural networks. In some examples, at least some of the nodes of a recurrent neural network can form a cycle.

Recurrent neural networks can be especially useful for processing input data that is sequential in nature. For example, a recurrent neural network can pass or retain information from a previous portion of the input data sequence to a subsequent portion of the input data sequence through the use of recurrent or directed cyclical node connections. Sequential input data may include words in a sentence (e.g., for natural language processing, speech detection or processing, etc.). In some examples, sequential input data can include time-series data (e.g., sensor data versus time or imagery captured at different times). In some examples, sequential input data may include time-series data (e.g., sensor data versus time or imagery captured at different times). For example, a recurrent neural network may analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks may include long short-term (LSTM) recurrent neural networks, gated recurrent units, bi-direction recurrent neural networks, continuous time recurrent neural networks, neural history compressors, echo state networks, Elman networks, Jordan networks, recursive neural networks, Hopfield networks, fully recurrent networks, sequence-to-sequence configurations, etc.

In some examples, LM module 244 can be or include one or more convolutional neural networks. In some examples, a convolutional neural network can include one or more convolutional layers that perform convolutions over input data using learned filters. Filters can also be referred to as kernels. Convolutional neural networks can be especially useful for vision problems such as when the input data includes imagery such as still images or video. However, convolutional neural networks can also be applied for natural language processing.

In some examples, ML module 224 may implement other machine-learned models that may be used in place of or in conjunction with LM module 244. ML module 224 may perform various types of natural language processing (NLP) based on the input data (i.e., the prompt and one or more limited representations of the comment section) that ML module 224 receives. For example, ML module 224 may summarize, translate, or organize the input data and, in some implementations, ML module 224 may perform summarization, regression, clustering, anomaly detection, and/or other tasks.

ML module 224 may perform various types of clustering. For example, ML module 224 may identify one or more previously defined clusters to which the input data (i.e., a comment) most likely corresponds. ML module 224 may identify one or more clusters within the input data. That is, in instances in which the input data includes multiple comments, ML module 224 may sort the multiple comments included in the input data into a number of clusters. In some examples, in which ML module 224 performs clustering, ML module 224 may be trained using unsupervised learning techniques.

ML module 224 may perform anomaly detection or outlier detection. For example, ML module 224 may identify comments that do not conform to an expected pattern or other characteristic (e.g., as previously observed from previous comments). As an example, anomaly detection may be used for detecting comments that are offensive or inappropriate.

In some implementations, ML module 224 may perform regression to provide output data in the form of a continuous numeric value. The continuous numeric value may correspond to any number of different metrics or numeric representations, including, for example, currency values, scores, or other numeric representations. In examples, ML module 224 may perform linear regression, polynomial regression, or nonlinear regression. In examples, ML module 224 may perform simple regression or multiple regression. As described above, in some implementations, a Softmax function or other function or layer may be used to squash a set of real values respectively associated with two or more possible classes to a set of real values in the range (0, 1) that sum to one.

ML module 224 may be or include one or more of various different types of machine-learned models. Examples of such different types of machine-learned models are provided below for illustration. One or more of the example models described below may be used (e.g., combined) to provide the output data in response to the input data. Additional models beyond the example models provided below may be used as well.

In some implementations, ML module 224 may be or include one or more classifier models such as, for example, linear classification models; quadratic classification models; etc. ML module 224 may be or include one or more regression models such as, for example, simple linear regression models; multiple linear regression models; logistic regression models; stepwise regression models; multivariate adaptive regression splines; locally estimated scatterplot smoothing models; etc.

In some implementations, ML module 224 may be or include one or more artificial neural networks (also referred to simply as neural networks). A neural network may include a group of connected nodes, which also may be referred to as neurons or perceptrons. A neural network may be organized into one or more layers. Neural networks that include multiple layers may be referred to as “deep” networks. A deep network may include an input layer, an output layer, and one or more hidden layers positioned between the input layer and the output layer. The nodes of the neural network may be connected or non-fully connected.

In some examples, ML module 224 may be or include one or more generative networks such as, for example, generative adversarial networks. Generative networks may be used to generate new data such as artificial feedback texts.

In an example in which the input data does not include feature embeddings, one or more neural networks may be used to provide an embedding based on the input data. For example, the embedding may be a representation of knowledge abstracted from the input data into one or more learned dimensions. In some instances, embeddings may be a useful source for identifying related entities. In some instances, embeddings may be extracted from the output of the network, while in other instances embeddings may be extracted from any hidden node or layer of the network (e.g., a close to final but not final layer of the network). Embeddings may be useful for performing auto-suggest next video, product suggestion, entity or object recognition, etc. In some instances, embeddings are useful inputs for downstream models. For example, embeddings may be useful to generalize input data (e.g., search queries) for a downstream model or processing system.

In some implementations, ML module 224 may perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some implementations, ML module 224 may be an autoregressive model. In some instances, an autoregressive model may specify that the output data depends linearly on its own previous values and on a stochastic term. In some instances, an autoregressive model may take the form of a stochastic difference equation. One example of an autoregressive model is WaveNet, which is a generative model for raw audio.

In some implementations, ML module 224 may include or form part of a multiple model ensemble. As one example, bootstrap aggregating may be performed, which may also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models may be combined (e.g., through averaging, voting, or other techniques) and used as the output of the ensemble.

One example ensemble is a random forest, which may also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees may be used as the output of the forest. Random decision forests may correct for decision trees' tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of the same or different type) may be trained based on training data. In addition, a combiner model may be trained to take the predictions from the other machine-learned models as inputs and, in response, produce a final inference or prediction. In some instances, a single-layer logistic regression model may be used as the combiner model.

Another example of ensemble techniques is boosting. Boosting may include incrementally building an ensemble by iteratively training weak models and then adding to a final strong model. For example, in some instances, each new model may be trained to emphasize the training examples that previous models misinterpreted (e.g., misclassified). For example, a weight associated with each of such misinterpreted examples may be increased. One common implementation of boosting is AdaBoost, which may also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) may be combined to form an ensemble. As an example, an ensemble may include a top-level machine-learned model or a heuristic function to combine and/or weight the outputs of the models that form the ensemble.

In some implementations, multiple machine-learned models (e.g., that form an ensemble may be linked and trained jointly (e.g., through backpropagation of errors sequentially through the model ensemble). However, in some implementations, only a subset (e.g., one) of the jointly trained models is used for inference.

In some implementations, ML module 224 may be used to preprocess the input data for subsequent input into another model. For example, ML module 224 may perform dimensionality reduction techniques and embeddings (e.g., matrix factorization, principal components analysis, singular value decomposition, word2vec/GLOVE, and/or related approaches); clustering; and even classification and regression for downstream consumption. Many of these techniques have been discussed above and will be further discussed below.

In some implementations, during training, the input data may be intentionally deformed in any number of ways to increase model robustness, generalization, or other qualities. Example techniques to deform the input data include adding noise; changing color, shade, or hue; magnification; segmentation; amplification; etc.

The techniques of the present disclosure may be implemented by or otherwise executed on one or more computing devices (e.g., computing device 102 of FIG. 1). Examples of such computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); other computing devices; or combinations thereof. Computing system 200 that implements machine learning module 224 or other aspects of the present disclosure may include a number of hardware components that enable the performance of the techniques described herein.

ML module 224 described herein may be trained according to one or more of various different training types or techniques. For example, in some implementations, ML module 224 may be trained using supervised learning, in which ML module 224 is trained on a training dataset that includes instances or examples that have labels. The labels may be manually applied by experts, generated through crowdsourcing, or provided by other techniques (e.g., by physics-based or complex mathematical models). In some implementations, if the user has provided consent, the training examples may be provided by the user computing device. In some implementations, this process may be referred to as personalizing the model.

In some implementations, backward propagation of errors may be used in conjunction with an optimization technique (e.g., gradient-based techniques) to train machine learning module 224 (e.g., when the machine-learned model is a multi-layer model such as an artificial neural network). For example, an iterative cycle of propagation and model parameter (e.g., weights) update may be performed to train machine learning module 224. Example backpropagation techniques include truncated backpropagation through time, Levenberg-Marquardt backpropagation, etc.

In some implementations, machine learning module 224 described herein may be trained using unsupervised learning techniques. Unsupervised learning may include inferring a function to describe hidden structure from unlabeled data. For example, a classification or categorization may not be included in the data. Unsupervised learning techniques may be used to produce machine-learned models capable of performing clustering, anomaly detection, learning latent variable models, or other tasks.

Machine learning module 224 may be trained using semi-supervised techniques which combine aspects of supervised learning and unsupervised learning. Machine learning module 224 may be trained or otherwise generated through evolutionary techniques or genetic algorithms. In some implementations, machine learning module 224 described herein may be trained using reinforcement learning. In reinforcement learning, an agent (e.g., model) may take actions in an environment and learn to maximize rewards and/or minimize penalties that result from such actions. Reinforcement learning may differ from the supervised learning problem in that correct input/output pairs are not presented, nor sub-optimal actions explicitly corrected.

In some implementations, one or more generalization techniques may be performed during training to improve the generalization of ML module 224. Generalization techniques may help reduce overfitting of ML module 224 to the training data. Example generalization techniques include dropout techniques; weight decay techniques; batch normalization; early stopping; subset selection; stepwise selection; label smoothing; etc.

In some implementations, ML module 224 described herein may include or otherwise be impacted by a number of hyperparameters, such as, for example, learning rate, number of layers, number of nodes in each layer, number of leaves in a tree, number of clusters; etc. Hyperparameters may affect model performance. Hyperparameters may be hand selected or may be automatically selected through the application of techniques such as, for example, grid search; black-box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some implementations, various techniques may be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some implementations, transfer learning techniques may be used to provide an initial model from which to begin training of ML module 224 described herein.

In some implementations, ML module 224 described herein may be included in different portions of computer-readable code on a computing device. In one example, ML module 224 may be included in a particular application or program and used (e.g., exclusively) by such particular application or program. Thus, in one example, a computing device may include a number of applications, and one or more of such applications may contain its own respective machine learning library and machine-learned model(s).

In another example, ML module 224 described herein may be included in an operating system of a computing device (e.g., in a central intelligence layer of an operating system) and may be called or otherwise used by one or more applications that interact with the operating system. In some implementations, each application may communicate with the central intelligence layer (and model(s) stored therein) using an application programming interface (API) (e.g., a common, public API across all applications).

In some implementations, the central intelligence layer may communicate with a central device data layer. The central device data layer may be a centralized repository of data for the computing device. The central device data layer may communicate with a number of other components of the computing device, such as, for example, one or more sensors, a context manager, a device state component, and/or additional components. In some implementations, the central device data layer may communicate with each device component using an API (e.g., a private API).

The technology discussed herein refers to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination.

Databases and applications may be implemented on a single system or distributed across multiple systems. Distributed components may operate sequentially or in parallel.

In addition, the machine learning techniques described herein are readily interchangeable and combinable. Although certain example techniques have been described, many others exist and may be used in conjunction with aspects of the present disclosure.

In some implementations, transfer learning (TL) may be used. Transfer learning involves reusing a model and its model parameters obtained while solving one problem and applying it to a different but related problem. Models trained on very large data sets may be retrained or finetuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step.

Thus, ML module 224 may apply LM module 244, in combination with or not in combination with one or more of the machine learning techniques described herein, to the prompt and limited representation of the comment section to generate an updated summary 246. In one example, the one or more summaries ML module 224 may generate, such as updated summary 246, may be referred to and considered as comment summaries. Comment management module 218 may then retrieve updated summary 246. Further, comment management module 218 may then store updated summary 246 in summary datastore 226. Further, comment management module 218 may send the updated summary 246, via communication channels 228, to user application 208. Updated summary 246 may be displayed as one or more of summaries 116A-116N by display device 106 to a user of user application 208 via GUI 110 as shown in FIG. 1.

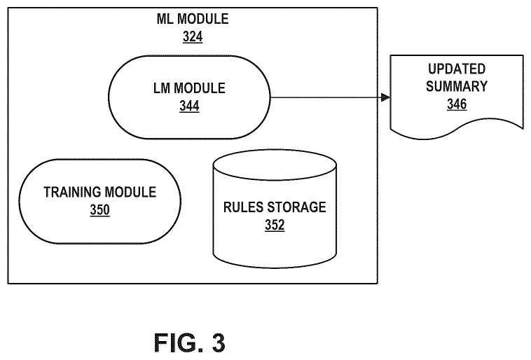

FIG. 3 is a block diagram illustrating in further detail a machine learning module configured to provide an updated summary, in accordance with one or more techniques of this disclosure. ML module 324 is one example of ML module 224 shown in FIG. 2 and ML 124 shown in FIG. 1. ML module 324 includes LM module 344, which may be an example of LM module 244 shown in FIG. 2, training module 350, and rules storage 352. ML module 324 may generate updated summary 346, which may be an example of updated summary 246 shown in FIG. 2.

In general, LM module 344 may accurately perform NLP tasks, such as generating text and other content. However, with respect to specific types of content (e.g., specific information types), LM module 344 may have an increased likelihood of generating false or inaccurate information. To address the issue of generating false information, LM module 344 may be configured to exclude the generation of content relating to a set of excluded information types. For example, the set of excluded information types may include one or more of phone numbers, addresses, web addresses, etc. Thus, the one or more limited representations of the comment section in the form of structured text may be passed in LM module 344 with certain perquisites, or “rules” that can be stored in rules storage 352. The rules may also be text inputs such as, “What is the most commonly discussed topic?”, “Have your summary avoid physical descriptions of people.”, and “Keep your summary short.” In other words, rules storage 352 may store a plurality of text inputs that further specify how updated summary 346 should be generated by LM module 344. In other words, LM module 344 is applied to the structured text in accordance with the one or more pre-defined rules stored in rules storage 352, which may include, for example, one or more of unauthorized terms, unauthorized topics, or unauthorized lengths of the summary of the comment section. Because LM module 344 can interpret the rules along with the structured text, computing system 200 can provide a more accurate and user-friendly summary of one or more portions of a comment section of a user application.

ML module 324 may include training module 350 that trains (e.g., pre-train, fine-tune, etc.) LM module 344. Training module 350 may pre-train LM module 344 on a large and diverse corpus of text. This dataset may cover a wide range of topics and domains to ensure LM module 344 learns diverse linguistic patterns and contextual relationships. Training module 350 may train LM module 344 to optimize an objective function. The objective function may be or include a loss function, such as cross-entropy loss, that compares (e.g., determines a difference between) output data generated by the model from the training data and labels (e.g., ground-truth labels) associated with the training data. For example, the objective function of LM module 344 may be to correctly predict the next word in a sequence of words or correctly fill in missing words as much as possible.

In some examples, training module 350 may continuously or periodically train LM module 344. In some examples, training module 350 may fine-tune LM module 344 by using feedback in the training process. For example, computing device 102 of FIG. 1 may receive user input via display device 106 displaying GUI 110. The user input may be feedback (e.g., thumbs up, thumbs down, etc.) relating to one or more summaries 116A-116N of FIG. 1. In some examples, the feedback may indicate whether the summary of one or more portions of the comment section is accurate or inaccurate, correct or incorrect, high quality or low quality, etc. User application 208 of FIG. 2 may receive the feedback. Further, user application 208 of FIG. 2 may send the feedback to storage devices 234 via communication channels 228. ML module 324 may obtain the feedback (specifically training module 350), in which training module 350 uses the feedback for training. For example, training module 350 may convert the feedback into labeled data for supervised training. Additionally, or alternatively, training module 350 may fine-tune LM module 344 by monitoring the relationship between the performance of LM module 344 and user feedback, and iterate the fine-tuning process as necessary (e.g., to receive more positive user feedback and less negative user feedback). In this way, the techniques of this disclosure may establish a feedback loop that continuously improves the quality of the output (i.e., updated summary 346) of LM module 344.

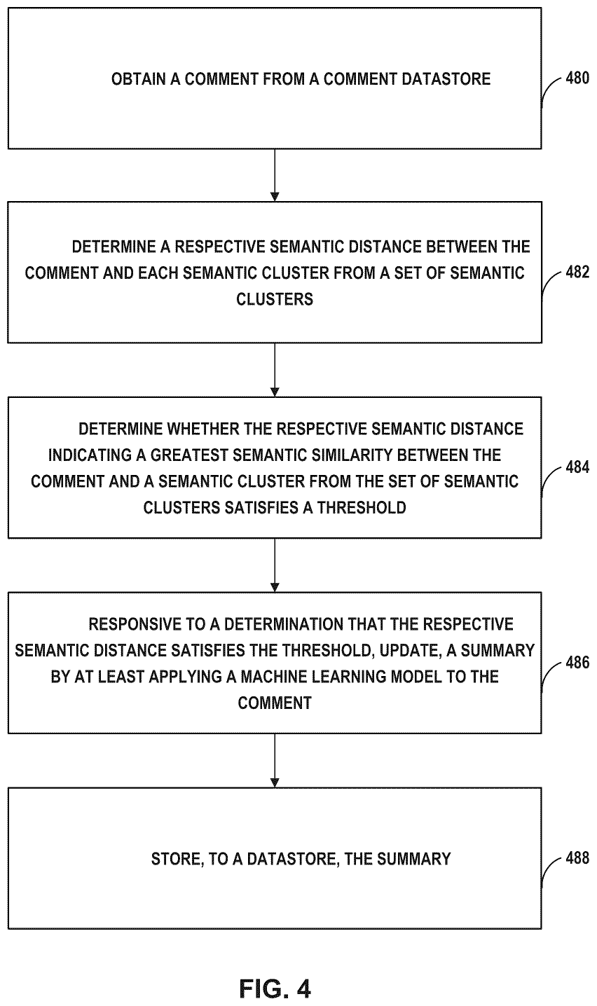

FIG. 4 is a flowchart illustrating an example operation of an example system that provides one or more summaries, in accordance with one or more techniques of this disclosure. Although the example operation of FIG. 4 is described as being performed by computing system 100 of FIG. 1 or computing system 200 of FIG. 2, in other examples some or all of the example operations may be performed by a computing device, such as computing device 102 of FIG. 1.

Summarization framework module 122 of computing system 100 may obtain a representation of a comment from comment datastore 120 (480). For instance, a user may submit a comment to comment section 114. Computing device 102 may send the user submitted comment, via network 104, to computing system 100. Comment management module 118 of computing system 100 may receive the comment. Further, comment management module 118 may store the comment in comment datastore 120. In one example, summarization framework module 122 may then retrieve the comment from comment datastore 120.

Differential logic module 236 of summarization framework module 222 of FIG. 2 may determine a respective semantic distance between the comment and each semantic cluster from a set of semantic clusters (482). The respective semantic distance between the comment and each semantic cluster may indicate how similar or dissimilar the content of the comment is to the content of each semantic cluster. By determining the semantic distance between the comment and each semantic cluster, differential logic module 236 may determine how similar or dissimilar the content of the comment is to the content of the comments within comment section 114.

Comment scorer module 238 of summarization framework module 222 of FIG. 2 may receive from differential logic module 236, a semantic distance indicating the greatest semantic similarity between the comment and a semantic cluster from the set of semantic clusters. Comment scorer module 238 may determine whether the semantic distance indicating the greatest semantic similarity between the comment and the semantic cluster from the set of semantic clusters satisfies a threshold (484). The threshold may be a value that indicates a corresponding level of similarity or dissimilarity between the content of the comment and the cluster.

In one example, comment scorer module 238 may determine that the semantic distance satisfies the threshold. This may indicate that the content of the comment is dissimilar to the content within each of the clusters. As a result, comment scorer module 238 may trigger a summary update by sending the relevant comment and cluster to prompt generation module 242 of summarization framework module 222 of FIG. 2. Prompt generation module 242 may apply one or more techniques to the comment and the one or more clusters to generate a prompt. Summarization framework module 222 may update a summary 246 of at least a portion of the comment section by at least applying machine learning model 124 to the comment (e.g., the prompt) (486). In one example, machine learning model 124 may be a language model, as illustrated by FIG. 3. Further, machine learning model 124 to generate the updated summary 246, may receive one or more limited representations of the comment section in addition to the prompt. For instance, machine learning model 124 may receive select past summaries and/or select past comments.

Comment management module 218 may retrieve updated summary 246. Comment management module 218 may store updated summary 246 in a datastore, such as comment datastore 220 (488). Further, comment management module 218 may send updated summary 246 to user application 208. Updated summary 246 may be displayed as one or more of summaries 116A-116N by display device 106 to a user of user application 108 via GUI 110 as shown in FIG. 1.

Furthermore, as generation of a summary of one or more portions of a comment section may come with a certain computational time and cost, it may be desirable to generate the summary using a limited representation of the comment section, and to only generate the summary if a new or edited comment causes a meaningful change in the comment section. By comparing a semantic distance indicating the greatest semantic similarity between a new or edited comment and a cluster of a set of clusters for a comment section to one or more thresholds, computing system 100 may generate an updated summary only when a meaningful change has occurred in the comment section. Further, by using a limited representation of the comment section to generate the updated summary, computing system 100 may reduce computation time, and thus may generate the updated summary in real or near real time. In this way, aspects of the disclosure may improve comment summarization using an LM while incurring fewer computational expenses than traditional LM summarization techniques.

Aspects of this disclosure include the following examples.

Example 1. A method comprising: obtaining, by a computing system, a comment from a comment datastore; determining, by the computing system, a respective semantic distance between the comment and each semantic cluster from a set of semantic clusters; determining, by the computing system, whether the respective semantic distance indicating a greatest semantic similarity between the comment and a semantic cluster from the set of semantic clusters satisfies a threshold; responsive to determining that the respective semantic distance satisfies the threshold, updating, by the computing system, a summary by at least applying a machine learning model to the comment, wherein the machine learning model is a language model; and storing, by the computing system and to a datastore, the summary.

Example 2. The method of example 1, wherein the threshold is a first threshold, the method further comprising: determining, by the computing system and based on the respective semantic distance satisfying the first threshold, whether the respective semantic distance satisfies a second threshold; responsive to determining that the respective semantic distance satisfies the second threshold, generating, by the computing system, a new semantic cluster for the set of semantic clusters, wherein the comment is assigned to the new semantic cluster; and responsive to determining that the respective semantic distance satisfies the second threshold, generating, by the computing system, a summary by at least applying a machine learning model to the comment.

Example 3. The method of any of examples 1-2, wherein the threshold is a first threshold, the method further comprising: determining, by the computing system and based on the respective semantic distance satisfying the first threshold, whether the respective semantic distance satisfies a second threshold; responsive to determining that the respective semantic distance does not satisfy the second threshold, assigning, by the computing system, the comment to the semantic cluster from the set of semantic clusters that corresponds to the semantic distance indicating the greatest semantic similarity; and updating, by the computing system, the summary.

Example 4. The method of any of examples 1-3, further comprising: responsive to determining that the respective semantic distance does not satisfy the threshold, assigning, by the computing system, the comment to the semantic cluster from the set of semantic clusters that corresponds to the semantic distance indicating the greatest semantic similarity; and refraining from updating, by the computing system, the summary.

Example 5. The method of any of examples 1-4, further comprising: responsive to determining that the respective semantic distance satisfies the threshold, updating, by the computing system, the summary by at least applying the machine learning model to the comment and to at least two previously updated comment summaries that are each associated with a different cluster of the set of clusters.

Example 6. The method of any of examples 1-5, further comprising: responsive to determining that the respective semantic distance satisfies the threshold, updating, by the computing system, the summary by at least applying the machine learning model to the comment and to at least two comments that previously satisfied the threshold and are each assigned to a different cluster of the set of clusters.

Example 7. The method of any of examples 1-6, wherein updating the summary further comprises providing, as input to the language model, one or more of: a prompt generated based on the comment; a prompt generated based on the comment and one or more clusters of the set of clusters; one or more comments that have previously satisfied the threshold; and one or more summaries.

Example 8. A computing system comprising: one or more processors; and one or more storage devices that store instructions, wherein the instructions, when executed by the one or more processors, configure the one or more processors to: obtain a comment from a comment datastore; determine a respective semantic distance between the comment and each semantic cluster from a set of semantic clusters; determine whether the respective semantic distance indicating a greatest semantic similarity between the comment and a semantic cluster from the set of semantic clusters satisfies a threshold; responsive to a determination that the respective semantic distance satisfies the threshold, update a summary by at least applying a machine learning model to the comment, wherein the machine learning model is a language model; and store the summary to a datastore.

Example 9. The computing system of example 8, wherein the threshold is a first threshold, and wherein the one or more processors are further configured to: determine, based on the respective semantic distance satisfying the first threshold, whether the respective semantic distance satisfies a second threshold; responsive to a determination that the respective semantic distance satisfies the second threshold, generate, a new semantic cluster for the set of semantic clusters, wherein the comment is assigned to the new semantic cluster; and responsive to a determination that the respective semantic distance satisfies the second threshold, generate, a summary by at least applying a machine learning model to the comment.

Example 10. The computing system of any of examples 8-9, wherein the threshold is a first threshold, and the one or more processors are further configured to: determine, based on the respective semantic distance satisfying the first threshold, whether the respective semantic distance satisfies a second threshold; responsive to a determination that the respective semantic distance does not satisfy the second threshold, assign, the comment to the semantic cluster from the set of semantic clusters that corresponds to the semantic distance indicating the greatest semantic similarity; and update the summary.

Example 11. The computing system of any of examples 8-10, wherein the one or more processors are further configured to: responsive to a determination that the respective semantic distance does not satisfy the threshold, assign, the comment to the semantic cluster from the set of semantic clusters that corresponds to the semantic distance indicating the greatest semantic similarity; and refrain from updating the summary.

Example 12. The computing system of any of examples 8-11, wherein the one or more processors are further configured to: responsive to a determination that the respective semantic distance satisfies the threshold, update, the summary by at least applying the machine learning model to the comment and to at least two previously updated comment summaries that are each associated with a different cluster of the set of clusters.

Example 13. The computing system of any of examples 8-12, wherein the one or more processors are further configured to: responsive to a determination that the respective semantic distance satisfies the threshold, update, the summary by at least applying the machine learning model to the comment and to at least two comments that previously satisfied the threshold and are each assigned to a different cluster of the set of clusters.

Example 14. The computing system of any of examples 8-13, wherein the one or more processors are further configured to update the summary by providing, as input to the language model, one or more of: a prompt generated based on the comment; a prompt generated based on the comment and one or more clusters of the set of clusters; one or more comments that have previously satisfied the threshold; and one or more summaries.

Example 15. A non-transitory computer-readable storage media encoded with instructions that, when executed by one or more processors of a computing system, cause the one or more processors to: obtain a comment from a comment datastore; determine a respective semantic distance between the comment and each semantic cluster from a set of semantic clusters; determine whether the respective semantic distance indicating a greatest semantic similarity between the comment and a semantic cluster from the set of semantic clusters satisfies a threshold; responsive to a determination that the respective semantic distance satisfies the threshold, update a summary by at least applying a machine learning model to the comment, wherein the machine learning model is a language model; and store the summary to a datastore.

Example 16. The non-transitory computer-readable storage media of example 15, wherein the threshold is a first threshold, and wherein the instructions further cause the one or more processors to: determine, based on the respective semantic distance satisfying the first threshold, whether the respective semantic distance satisfies a second threshold; responsive to a determination that the respective semantic distance satisfies the second threshold, generate, a new semantic cluster for the set of semantic clusters, wherein the comment is assigned to the new semantic cluster; and responsive to a determination that the respective semantic distance satisfies the second threshold, generate, a summary by at least applying a machine learning model to the comment.

Example 17. The non-transitory computer-readable storage media of any of examples 15-16, wherein the threshold is a first threshold, and wherein the instructions further cause the one or more processors to: determine, based on the respective semantic distance satisfying the first threshold, whether the respective semantic distance satisfies a second threshold; responsive to a determination that the respective semantic distance does not satisfy the second threshold, assign, the comment to the semantic cluster from the set of semantic clusters that corresponds to the semantic distance indicating the greatest semantic similarity; and update the summary.

Example 18. The non-transitory computer-readable storage media of any of examples 15-17, wherein the instructions further cause the one or more processors to: responsive to a determination that the respective semantic distance does not satisfy the threshold, assign, the comment to the semantic cluster from the set of semantic clusters that corresponds to the semantic distance indicating the greatest semantic similarity; and refrain from updating the summary.

Example 19. The non-transitory computer-readable storage media of any of examples 15-18, wherein the instructions further cause the one or more processors to: responsive to a determination that the respective semantic distance satisfies the threshold, update, the summary by at least applying the machine learning model to the comment and to at least two previously updated comment summaries that are each associated with a different cluster of the set of clusters.

Example 20. The non-transitory computer-readable storage media of any of examples 15-19, wherein the instructions further cause the one or more processors to: responsive to a determination that the respective semantic distance satisfies the threshold, update, the summary by at least applying the machine learning model to the comment and to at least two comments that previously satisfied the threshold and are each assigned to a different cluster of the set of clusters.

Example 21. The non-transitory computer-readable storage media of any of examples 15-20, wherein the instructions further cause the one or more processors to update the summary by providing, as input to the language model, one or more of: a prompt generated based on the comment; a prompt generated based on the comment and one or more clusters of the set of clusters; one or more comments that have previously satisfied the threshold; and one or more summaries.

Example 22. A computer-program product comprising instructions that, when executed, cause at least one processors of a computing system to perform the method of any of examples 1-7.

Example 23. A computing system comprising means for performing the method of any of examples 1-7.

Example 24. A computer-readable storage medium encoded with instructions that, when executed by one or more processors, cause the one or more processors to perform the method of any of examples 1-7.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
obtaining, by a computing system, a comment from a comment datastore;
determining, by the computing system, a respective semantic distance between the comment and each semantic cluster from a set of semantic clusters;
determining, by the computing system, whether the respective semantic distance indicating a greatest semantic similarity between the comment and a semantic cluster from the set of semantic clusters satisfies a threshold;
responsive to determining that the respective semantic distance satisfies the threshold, updating, by the computing system, a summary by at least applying a machine learning model to the comment, wherein the machine learning model is a language model; and
storing, by the computing system and to a datastore, the summary.

2. The method of claim 1, wherein the threshold is a first threshold, the method further comprising:
determining, by the computing system and based on the respective semantic distance satisfying the first threshold, whether the respective semantic distance satisfies a second threshold;
responsive to determining that the respective semantic distance satisfies the second threshold, generating, by the computing system, a new semantic cluster for the set of semantic clusters, wherein the comment is assigned to the new semantic cluster; and
responsive to determining that the respective semantic distance satisfies the second threshold, generating, by the computing system, a summary by at least applying a machine learning model to the comment.

3. The method of claim 1, wherein the threshold is a first threshold, the method further comprising:
determining, by the computing system and based on the respective semantic distance satisfying the first threshold, whether the respective semantic distance satisfies a second threshold;
responsive to determining that the respective semantic distance does not satisfy the second threshold, assigning, by the computing system, the comment to the semantic cluster from the set of semantic clusters that corresponds to the semantic distance indicating the greatest semantic similarity; and
updating, by the computing system, the summary.

4. The method of claim 1, further comprising:
responsive to determining that the respective semantic distance does not satisfy the threshold, assigning, by the computing system, the comment to the semantic cluster from the set of semantic clusters that corresponds to the semantic distance indicating the greatest semantic similarity; and
refraining from updating, by the computing system, the summary.

5. The method of claim 1, further comprising:
responsive to determining that the respective semantic distance satisfies the threshold, updating, by the computing system, the summary by at least applying the machine learning model to the comment and to at least two previously updated comment summaries that are each associated with a different cluster of the set of clusters.

6. The method of claim 1, further comprising:
responsive to determining that the respective semantic distance satisfies the threshold, updating, by the computing system, the summary by at least applying the machine learning model to the comment and to at least two comments that previously satisfied the threshold and are each assigned to a different cluster of the set of clusters.

7. The method of claim 1, wherein updating the summary further comprises providing, as input to the language model, one or more of:
a prompt generated based on the comment;
a prompt generated based on the comment and one or more clusters of the set of clusters;
one or more comments that have previously satisfied the threshold; and
one or more summaries.

8. A computing system comprising:
one or more processors; and
one or more storage devices that store instructions, wherein the instructions, when executed by the one or more processors, configure the one or more processors to:
obtain a comment from a comment datastore;
determine a respective semantic distance between the comment and each semantic cluster from a set of semantic clusters;
determine whether the respective semantic distance indicating a greatest semantic similarity between the comment and a semantic cluster from the set of semantic clusters satisfies a threshold;
responsive to a determination that the respective semantic distance satisfies the threshold, update a summary by at least applying a machine learning model to the comment, wherein the machine learning model is a language model; and
store the summary to a datastore.

9. The computing system of claim 8, wherein the threshold is a first threshold, and wherein the one or more processors are further configured to:
determine, based on the respective semantic distance satisfying the first threshold, whether the respective semantic distance satisfies a second threshold;
responsive to a determination that the respective semantic distance satisfies the second threshold, generate, a new semantic cluster for the set of semantic clusters, wherein the comment is assigned to the new semantic cluster; and
responsive to a determination that the respective semantic distance satisfies the second threshold, generate, a summary by at least applying a machine learning model to the comment.

10. The computing system of claim 8, wherein the threshold is a first threshold, and the one or more processors are further configured to:
determine, based on the respective semantic distance satisfying the first threshold, whether the respective semantic distance satisfies a second threshold;
responsive to a determination that the respective semantic distance does not satisfy the second threshold, assign, the comment to the semantic cluster from the set of semantic clusters that corresponds to the semantic distance indicating the greatest semantic similarity; and
update the summary.

11. The computing system of claim 8, wherein the one or more processors are further configured to:
responsive to a determination that the respective semantic distance does not satisfy the threshold, assign, the comment to the semantic cluster from the set of semantic clusters that corresponds to the semantic distance indicating the greatest semantic similarity; and
refrain from updating the summary.

12. The computing system of claim 8, wherein the one or more processors are further configured to:
responsive to a determination that the respective semantic distance satisfies the threshold, update, the summary by at least applying the machine learning model to the comment and to at least two previously updated comment summaries that are each associated with a different cluster of the set of clusters.

13. The computing system of claim 8, wherein the one or more processors are further configured to:
responsive to a determination that the respective semantic distance satisfies the threshold, update, the summary by at least applying the machine learning model to the comment and to at least two comments that previously satisfied the threshold and are each assigned to a different cluster of the set of clusters.

14. The computing system of claim 8, wherein the one or more processors are further configured to update the summary by providing, as input to the language model, one or more of:
a prompt generated based on the comment;
a prompt generated based on the comment and one or more clusters of the set of clusters;
one or more comments that have previously satisfied the threshold; and
one or more summaries.

15. A non-transitory computer-readable storage media encoded with instructions that, when executed by one or more processors of a computing system, cause the one or more processors to:
obtain a comment from a comment datastore;
determine a respective semantic distance between the comment and each semantic cluster from a set of semantic clusters;
determine whether the respective semantic distance indicating a greatest semantic similarity between the comment and a semantic cluster from the set of semantic clusters satisfies a threshold;
responsive to a determination that the respective semantic distance satisfies the threshold, update a summary by at least applying a machine learning model to the comment, wherein the machine learning model is a language model; and
store the summary to a datastore.

16. The non-transitory computer-readable storage media of claim 15, wherein the threshold is a first threshold, and wherein the instructions further cause the one or more processors to:
determine, based on the respective semantic distance satisfying the first threshold, whether the respective semantic distance satisfies a second threshold;
responsive to a determination that the respective semantic distance satisfies the second threshold, generate, a new semantic cluster for the set of semantic clusters, wherein the comment is assigned to the new semantic cluster; and
responsive to a determination that the respective semantic distance satisfies the second threshold, generate, a summary by at least applying a machine learning model to the comment.

17. The non-transitory computer-readable storage media of claim 15, wherein the threshold is a first threshold, and wherein the instructions further cause the one or more processors to:
determine, based on the respective semantic distance satisfying the first threshold, whether the respective semantic distance satisfies a second threshold;
responsive to a determination that the respective semantic distance does not satisfy the second threshold, assign, the comment to the semantic cluster from the set of semantic clusters that corresponds to the semantic distance indicating the greatest semantic similarity; and
update the summary.

18. The non-transitory computer-readable storage media of claim 15, wherein the instructions further cause the one or more processors to:
responsive to a determination that the respective semantic distance does not satisfy the threshold, assign, the comment to the semantic cluster from the set of semantic clusters that corresponds to the semantic distance indicating the greatest semantic similarity; and
refrain from updating the summary.

19. The non-transitory computer-readable storage media of claim 15, wherein the instructions further cause the one or more processors to:
responsive to a determination that the respective semantic distance satisfies the threshold, update, the summary by at least applying the machine learning model to the comment and to at least two previously updated comment summaries that are each associated with a different cluster of the set of clusters.

20. The non-transitory computer-readable storage media of claim 15, wherein the instructions further cause the one or more processors to:
responsive to a determination that the respective semantic distance satisfies the threshold, update, the summary by at least applying the machine learning model to the comment and to at least two comments that previously satisfied the threshold and are each assigned to a different cluster of the set of clusters.
